(19) United States
(12) Patent Application Publication
(10) Pub. No.: US 2014/0255080 A1
(43) Pub. Date: Sep. 11, 2014

(54) SCRATCH AND SNIFF DELIVERY SYSTEMS AND METHODS OF USING THE SAME

(71) Applicant: Crayola LLC, Easton, PA (US)

(72) Inventors: Craig Skinner, Easton, PA (US); Brian Nemeckay, Belvidere, NJ (US); Michael Craig, Sciota, PA (US)

(21) Appl. No.: 14/204,406

(22) Filed: Mar. 11, 2014

Related U.S. Application Data
(60) Provisional application No. 61/775,996, filed on Mar. 11, 2013.

(51) Int. Cl. C09D 11/00

(52) U.S. Cl. CPC C09D 11/00
USPC 401/258; 106/31.13; 427/299; 427/372.2; 401/261

(57) ABSTRACT

A scratch and sniff kit comprises a plurality of scratch and sniff inks, wherein each ink comprises a different microencapsulated fragrance. The kit may further include a device, wherein each scratch and sniff ink is disposed within the device. A method of using the kit comprises dispensing at least two scratch and sniff inks from the device and mixing the inks together to form a mixture that releases a unique fragrance.

### CROSS-REFERENCE TO RELATED APPLICATIONS

This application claims the benefit of priority of U.S. Provisional Application No. 61/775,996, filed on Mar. 11, 2013, which is incorporated by reference herein, in its entirety and for all purposes.

### FIELD OF THE INVENTION

The present invention relates generally to inks that comprise microencapsulated fragrances. In particular, the invention relates to inks that can be used to apply “scratch and sniff” areas to various substrates, such as paper or fabric.

### BACKGROUND

“Scratch and sniff” technology is well-known and has been used to combine fragrance effects with printed material. For example, microencapsulated fragrances have been used to create “scratch and sniff” books, stickers, or advertisements. A user can scratch the printed areas resulting in a rupture of microcapsules that causes the fragrance to be released and smelled. There remains a need for new, creative uses of “scratch and sniff” applications that enables users to create custom-scented items, such as artwork or clothing.

### SUMMARY OF THE INVENTION

An embodiment of the present invention provides a scratch and sniff kit comprising a plurality of scratch and sniff inks, wherein each ink comprises a different microencapsulated fragrance; and one or more optional applicators for applying the scratch and sniff inks to a substrate. The kit may further include a device, wherein each scratch and sniff ink is disposed within the device. The device preferably includes actuating means for dispensing each ink.

Another embodiment of the present invention provides a method of using the kit comprising dispensing at least two scratch and sniff inks from the device by operating the actuating means (e.g., by pressing a button designated for each ink) and mixing the scratch and sniff inks together to form a mixture. The mixture may then be applied to a substrate (e.g., fabric, paper, or posterboard), for example, by using an applicator, such as a stylus, sponge, stamp, or pad.

### BRIEF DESCRIPTION OF THE FIGURES

The invention may be further understood by reference to the figures in which:

FIG. 1 illustrates a device for dispensing scratch and sniff inks, in accordance with an embodiment of the present invention; and

FIG. 2 illustrates a palette for use with scratch and sniff inks, in accordance with an embodiment of the present invention.

### DETAILED DESCRIPTION OF THE INVENTION

The present invention provides “scratch and sniff” kits and delivery systems that enable users to apply microencapsulated fragrances to substrates in creative ways; for example, by mixing various scents together and applying them to a substrate. The microencapsulated fragrances have “scratch and sniff” capabilities, so that after they have been applied to a substrate and subsequently dried, a user can scratch them to release a fragrance.

As used herein, a “scratch and sniff ink” comprises a microencapsulated fragrance dispersed in a liquid vehicle (preferably water-based). Microencapsulated fragrances are known in the art, and are commercially available. The microencapsulated fragrance is preferably in the form of liquid fragrance contained inside frangible capsules. Preferably, the capsules are sufficiently strong so that they typically do not rupture while wet, but after the ink has dried on a substrate, the capsules can be mechanically ruptured to release the fragrance, such as by scratching or rubbing the dried ink.

The scratch and sniff ink is preferably colorless, or substantially colorless (e.g., the ink may have a slightly pale white hue), but may be optionally colored (e.g., red, blue, green, etc.). A user can create custom “scratch and sniff” areas on various substrates, as opposed to purchasing articles with pre-made scratch and sniff designs and/or scents. The substrates include any article with a paintable surface. Non-limiting examples of substrates include fabric, paper, posterboard, stickers, etc. According to one embodiment, a user can “mark” clothing or other washable fabrics with the ink to create custom-scented apparel. The ink can then be reapplied to the fabric after washing. According to alternative embodiments, a user can mark other types of substrates, such as paper, posterboard, stickers, etc.

The scratch and sniff ink can be applied to a substrate with any type of applicator. According to particular embodiments, the ink can be applied with a marker, stylus, paintbrush, stamp, squeeze bottle, sponge, pad, or a user's finger(s). Release of the scent can be accomplished by scratching the ink after it has dried, or by the capsules rubbing against each other during movement of a fabric while it is being worn. The same or different inks can be reapplied to a fabric after washing.

According to an embodiment of the present invention, a scratch and sniff kit comprises, consists essentially of, or consists of a plurality of scratch and sniff inks, and optionally one or more applicators (e.g., marker(s), stylus(es), paintbrush(es), stamp(s), pad(s), etc.) for applying the inks to a substrate (e.g., fabric, paper, posterboard, stickers, etc.). Each ink preferably comprises a different microencapsulated fragrance—according to this embodiment, the kit may include a plurality of scratch and sniff inks that comprise the same microencapsulated fragrance, as long as there is also a plurality of scratch and sniff inks that have different microencapsulated fragrances with respect to one another. For example, the kit may include two or more scratch and sniff inks that release a “grape” smell upon scratching, and also include one or more scratch and sniff inks with a different fragrance, such as orange and/or lemon. The ink may be washable from the substrate, which means it is removable from the substrate by applying water, or soap and water. The ink may comprise one or more additives. Non-limiting examples of such additives include pigments, binders, pH adjusters, humectants, buffers, defoamers, preservatives, and dispersing agents. The kit may optionally comprise instructions for a user to apply the ink to a substrate, and to subsequently dry the substrate (or allow the substrate to air dry).

According to an alternative embodiment, the scratch and sniff kit includes at least one ink base (which may be clear and/or colored) in addition to the plurality of scratch and sniff inks. The ink base does not contain any microencapsulated fragrances, and is preferably a water-based ink. One or more of the scratch and sniff inks can then be mixed into the ink base. According to a particular embodiment, the scratch and sniff kit includes an ink base and a plurality of scratch and sniff inks having different fragrances (i.e., inks that provides different fragrances after they are dried on a substrate and ruptured by scratching). A user can add a single scratch and sniff ink to the ink base (or a portion of the ink base), or the user can add two or more different scratch and sniff inks to the ink base (or a portion of the ink base), so that the various microencapsulated fragrances mix together in the ink base to create unique fragrances upon scratching. The ink base mixed with the one or more scratch and sniff inks can be applied to a substrate (e.g., with an applicator).

According to a particular embodiment, the kit includes a plurality of containers, with each container housing a scratch and sniff ink having a different fragrance (i.e., each container housing a scratch and sniff ink that provides a different fragrance after it is dried on a substrate and ruptured by scratching). A user can mix two or more inks together to combine the microencapsulated fragrances that will be released when the microcapsules rupture, and then apply the unique mixture to one or more substrates. The individual scents may include, for example, cherry, strawberry, orange, banana, lemon, lime, berry (e.g., blueberry), grape, etc. According to preferred embodiments, the kit further comprises one or more applicators, for example, one or more styluses, paintbrushes, pads and/or stamps.

According to another embodiment, the kit includes a dispensing device, whereby a plurality of different scratch and sniff inks (i.e., that release different fragrances when their microencapsulated fragrances rupture) are disposed within the device. Each ink may optionally be contained within a separate container, with each container disposed within the device. The kit includes at least two inks that release different fragrances, e.g., between two to twenty inks, between two to fifteen inks, or between two to ten inks. The device includes actuating means operable by the user, with each actuating means configured (e.g., mechanically or electronically) to release each ink through an opening or orifice in the device (or through an opening or orifice in a container within the device). Preferably, the device includes separate actuating means for each ink. Non-limiting examples of the actuating means include buttons, levers, knobs, dials, or other components that cause the ink to be released through an opening or orifice in the device (or through an opening or orifice in its container that is housed within the device) when a user operates the actuating means (e.g., by pressing a button, turning a dial, pulling a lever, etc.).

According to a preferred embodiment, a user can dispense each scent from the device (optionally from a container within the device) by operating an actuating means for each ink; for example, by pressing a button that is specific for each ink. In one embodiment, a user mixes two or more of the scratch and sniff inks together after dispensing the scratch and sniff inks from the device. A user can mix various inks together to create unique fragrances (that will be released upon drying and subsequently scratching), and then apply the mixture to one or more substrates. The individual scents may include, for example, cherry, strawberry, orange, banana, lemon, lime, berry (e.g., blueberry), grape, etc. According to preferred embodiments, the kit further includes one or more applicators, for example, one or more styluses, paintbrushes, pads and/or stamps. The kit may further comprise at least one ink base, so that a user can mix the scratch and sniff ink(s) with the ink base, or a portion of the ink base, following dispensation, and then apply the mixture to a substrate.

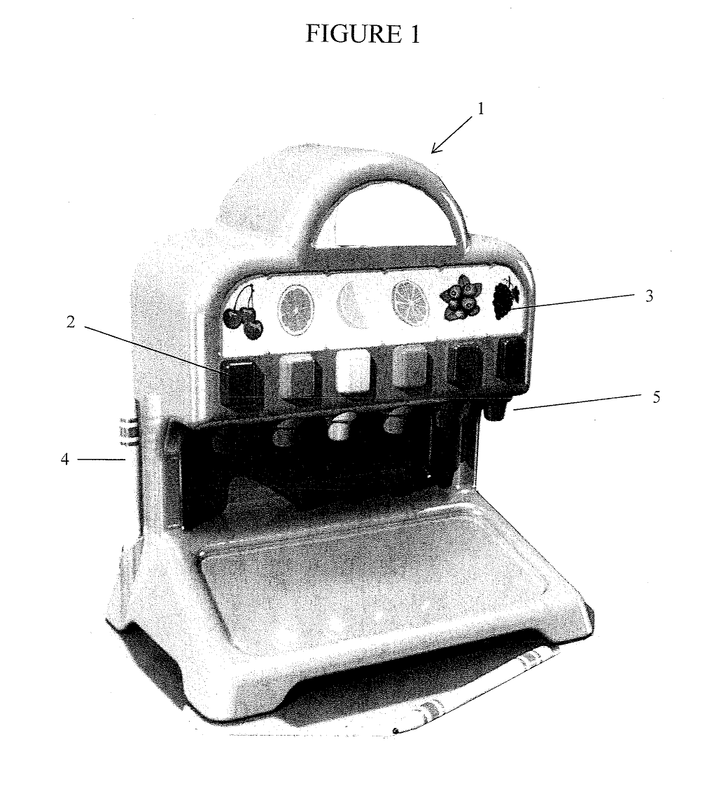

According to an exemplary embodiment, as illustrated in FIG. 1, the kit includes a dispensing device 1 that is analogous to a soda dispenser, whereby a user can release each scratch and sniff ink from an opening or orifice 5 by operating each actuating means 2 (e.g., by pressing each button 2). As shown in FIG. 1, each actuating means 2 may have a label 3, which illustrates the type of scent that will be released from its container (e.g., cherry, orange, lemon, lime, blueberry, grape, as shown in FIG. 1). The user can mix different scents together in a mixing container (e.g., a tray or bowl), if desired, prior to applying the one or more scents to a substrate. The kit may include at least one applicator 4, such as a stylus, pad, stamp, or paintbrush. According to an alternative embodiment, a user touches one or more of the orifices with an applicator, such as a stamp or a pad (e.g., a soft cotton pad, foam pad, or cloth). This causes the one or more inks to transfer from the orifice(s) to the stamp or the pad (e.g., a pad can at least partially “soak up” one or more of the inks from the orifice(s)). For example, a user can combine two or more of the inks on a stamp or pad. The user can then use the stamp or pad to apply the ink(s) to a substrate.

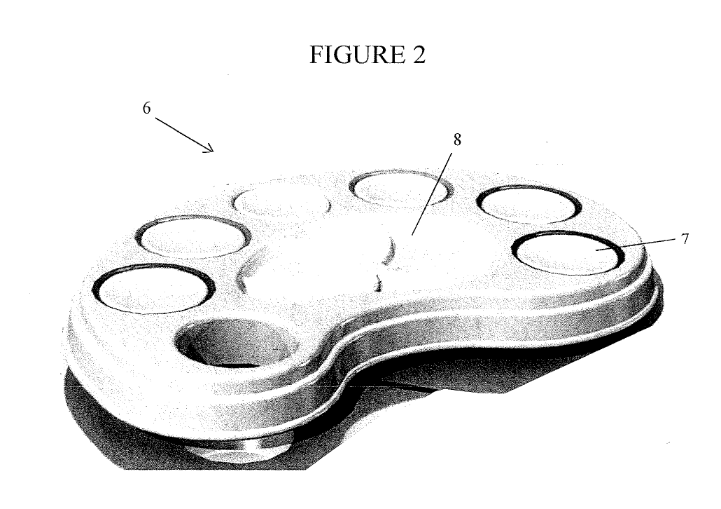

According to another embodiment, as illustrated in FIG. 2, the kit includes a palette 6. Different scratch and sniff inks may be disposed in separate trays or depressions 7 on the palette. The palette may also include a mixing tray 8 for mixing various inks together. According to alternative embodiments, each depression 7 holds a microencapsulated fragrance in solid form (instead of liquid form). A user then adds a solvent (preferably water) to the solid microencapsulated fragrance so that the microencapsulated fragrance becomes dispersed in the solvent to create a scratch and sniff ink. The user can mix the inks in the mixing tray 8, if desired, and apply the mixture to a substrate.

According to particular embodiments, the substrate comprises, consists essentially of, or consists of fabric, such as an item of clothing. As used herein, “fabric” (which is interchangeable with the term “cloth”) comprises or consists of strands of natural and/or synthetic fibers (e.g., yarn and/or thread) that have been woven together (such as by weaving or knitting) so that they are interlaced. The fabric may comprise, for example, an item of clothing or an accessory, such as a shirt (e.g., a t-shirt), pair of pants, skirt, dress, sock, undergarment, hat, glove, jacket, or handbag. Examples of the types of fabric that may be used include natural fabric, synthetic fabric, or blends of natural and synthetic fabric, e.g., cotton, nylon, polyester, rayon, silk, wool, or blends thereof. Particularly preferred types of fabric used in accordance with the present invention comprise or consist of 100% cotton, polyester, or a cotton/polyester blend (e.g., 50% cotton and 50% polyester, or 60% cotton and 40% polyester). In particular embodiments, the fabric consists of 100% cotton or a blend of cotton and polyester.

According to an embodiment of the present invention, a method of using the “scratch and sniff” delivery systems described herein comprises applying the scratch and sniff ink to a substrate (e.g., fabric, paper, posterboard, etc.), wherein the ink comprises one or more microencapsulated fragrances. After the ink dries, a user can release the scent by scratching or rubbing the dried ink. The ink may be removable by washing the substrate and/or drying the substrate in a clothes dryer (the tumbling action in a dryer may cause the microencapsulated fragrances to rub off of the fabric). The ink can then be re-applied to the substrate one or more times after washing or drying. The step of drying the ink on the substrate may not require any additional action on the part of the user, i.e., the step of drying may comprise allowing the ink to air dry on the substrate. For example, the ink may be allowed to air dry at room temperature. Alternatively, the step of drying the substrate may comprise applying heat to the substrate (e.g., by a blow dryer).

According to another embodiment, the method further comprises mixing two or more scratch and sniff inks together and subsequently applying the mixture to a substrate (e.g., with an applicator). For example, the method may comprise dispensing two or more liquid scratch and sniff inks from a dispensing device (preferably, the liquid scents are dispensed separately, e.g., by operating an actuating means, such as by pressing a button, specific for each scent) and mixing the scratch and sniff inks together.

Although the present invention has been described in connection with specific embodiments, it should be understood that the invention as claimed should not be unduly limited to such specific embodiments. Indeed, various modifications and variations of the described compositions and methods of the invention will be apparent to those of ordinary skill in the art and are intended to be within the scope of the appended claims.

What is claimed is:

1. A scratch and sniff kit comprising:
a plurality of scratch and sniff inks, wherein each ink comprises a different microencapsulated fragrance; and
one or more optional applicators for applying the scratch and sniff inks to a substrate.

2. The kit according to claim 1, wherein the one or more optional applicators comprise one or more pads, one or more markers, one or more styluses, one or more stamps, one or more paintbrushes, or a combination thereof.

3. The kit according to claim 1, wherein the inks are substantially colorless.

4. The kit according to claim 1, wherein the substrate is fabric.

5. The kit according to claim 4, wherein the substrate is an item of clothing.

6. The kit according to claim 1, wherein the substrate is paper or posterboard.

7. The kit according to claim 1, wherein each scratch and sniff ink further comprises one or more additives selected from the group consisting of pigments, binders, pH adjusters, humectants, buffers, defoamers, preservatives, dispersing agents, and a combination thereof.

8. The kit according to claim 1, wherein the scratch and sniff inks are disposed within a device.

9. The kit according to claim 8, wherein the device comprises actuating means for dispensing each scratch and sniff ink from the device.

10. A method of using the kit according to claim 9 comprising dispensing at least one scratch and sniff ink from the device by operating the actuating means.

11. A method of using the kit according to claim 9 comprising dispensing at least two scratch and sniff inks from the device by operating the actuating means and subsequently mixing the at least two scratch and sniff inks together to form a mixture.

12. The method according to claim 11 further comprising applying the mixture to a substrate.

13. The method according to claim 10 further comprising drying the scratch and sniff ink and releasing the scent of the microencapsulated fragrance(s) by scratching or rubbing the dried ink.

14. The method according to claim 13 further comprising washing the substrate and subsequently applying scratch and sniff ink to the substrate one or more additional times.
